(19) United States
(12) Patent Application Publication
(10) Pub. No.: US 2024/0123962 A1
(43) Pub. Date: Apr. 18, 2024

(54) APPARATUS FOR DRUM BRAKE ASSEMBLY

(71) Applicant: ZF Active Safety US Inc., Livonia, MI (US)

(72) Inventor: Galus Chelaidite, South Lyon, MI (US)

(21) Appl. No.: 17/965,305

(22) Filed: Oct. 13, 2022

(51) Int. Cl. B60T 13/58; B60T 13/12; F16D 51/22; F16D 51/24

(52) U.S. Cl. CPC B60T 13/588; B60T 13/12; F16D 51/22; F16D 51/24; F16D 2121/04

(57) ABSTRACT

An apparatus for a drum brake assembly having a brake drum and an actuator includes a shoe spreader web with a first side for connecting to a first piston of the actuator and a second side for connecting to a second piston of the actuator. A first brake shoe is secured to the first side of the web. A second brake shoe is secured to the second side of the web. The brake shoes have a first condition in which the respective first and second sides of the web move the brake shoes to apply braking force to the brake drum in response to actuation of the actuator. The first brake shoe has a second condition moving relative to the web for absorbing brake drum contraction forces and prevent the full magnitude of these forces from reaching the actuator clevises.

### TECHNICAL FIELD

The present invention relates generally to braking systems, and specifically to brake shoes decoupled from the actuator for a drum brake assembly.

### BACKGROUND

Drum-in-hat parking brakes are typically provided on the rear wheels of vehicles in order to a apply a parking brake to the vehicle wheels. The drum-in hat brakes include brake shoes selectively movable away from one another and into engagement with the brake drum to apply braking force to the brake drum via the friction material bonded to each brake shoe. The brake shoes are locked in this position to apply and hold the parking brake until released by the vehicle operator.

### SUMMARY

In one aspect of the invention, an apparatus for a drum brake assembly having a brake drum and an actuator includes a shoe spreader web with a first side for connecting to a first clevis of the actuator and a second side for connecting to a second clevis of the actuator. A first brake shoe is secured to the first side of the web. A second brake shoe is secured to the second side of the web. The brake shoes have a first condition in which the respective first and second sides of the web move the brake shoes to apply braking force to the brake drum in response to actuation of the actuator. The first brake shoe has a second condition moving relative to the web for absorbing brake drum contraction forces.

In another aspect, an apparatus for a drum brake assembly having a brake drum and an actuator includes a shoe spreader web. The web includes a first side for connecting to a first clevis of the actuator and having first and second slots. A second side is provided for connecting to a second clevis of the actuator and has first and second slots. The first and second slots in the first and second sides of the web are collectively circumferentially arranged about a common axis. A first brake shoe is secured to the first side of the web includes first and second slots. A second brake shoe is secured to the second side of the web and includes first and second slots. Pins extend through the first and second slots in each of the first and second sides of the web and through the intersection of the corresponding first and second slots in each of the first and second brake shoes for connecting the brake shoes to the web and transferring actuator loads from the first and second sides of the web to the respective first and second brake shoes. The brake shoes have a first condition in which the respective first and second sides of the web move the brake shoes to apply braking force to the brake drum in response to actuation of the actuator. The first brake shoe has a second condition moving relative to the web for absorbing brake drum contraction forces.

Other objects and advantages and a fuller understanding of the invention will be had from the following detailed description and the accompanying drawings.

### BRIEF DESCRIPTION OF THE DRAWINGS

FIG. 1 is a schematic illustration of a vehicle having a drum brake assembly in accordance with an aspect of the present invention.

FIG. 2 is a schematic illustration of a drum-in-hat brake rotor of the drum brake assembly.

FIG. 3A is schematic illustration of an adapter, splash shield, and brake shoes of the drum brake assembly.

FIG. 3B is an enlarged view of a portion of FIG. 3A.

FIG. 4 is a front view of the brake shoe.

FIG. 5 is a front view of a web for connection to both brake shoes.

FIG. 6 is a front view of a link for each brake shoe.

FIG. 7 is a pin for connecting the link to the brake shoes and web.

FIG. 8A is a schematic illustration of the brake drum assembly when an braking operation is initiated.

FIG. 8B is a schematic illustration in which the brake shoe has a first condition moving with the web during braking.

FIG. 8C is a schematic illustration in which the brake shoe has a second condition moving relative to the web during cooling of the drum.

### DETAILED DESCRIPTION

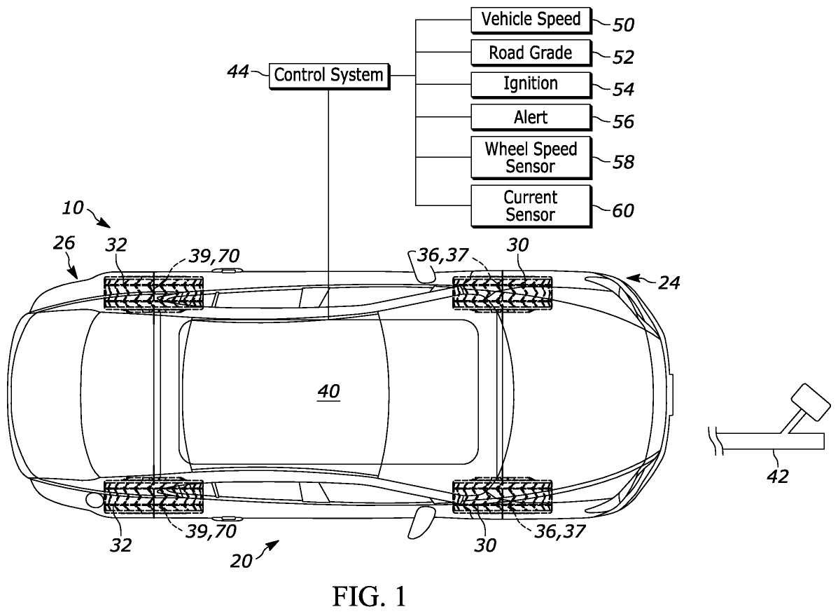

The present invention relates generally to braking systems, and specifically to a deflectable pivot lever for a drum brake assembly. FIG. 1 illustrates an example electric brake/braking system 10 for a motor vehicle 20 in accordance with the present invention.

The vehicle 20 extends from a first or front end 24 to a second or rear end 26. A pair of steerable wheels 30 is provided at the front end 24. Each wheel 30 includes a wheel rotor 36 driven and steered by a steering linkage (not shown). Disc brakes 37 are associated with each wheel rotor 36. A brake pedal 42 can be used to actuate the disc brakes 37 to apply service braking to the wheels 30.

A pair of steerable or non-steerable wheels 32 is provided at the rear end 26. Each rear wheel 32 includes a wheel rotor 70 driven by a steering linkage (not shown). Drum brake assemblies 39, e.g., drum-in-hat brake assemblies, are associated with each wheel rotor 70. A propulsion system 40, e.g., an engine and/or battery, supplies torque to the wheels 30.

A control system 44 is provided to help control operation of the vehicle 20, such as operation of the propulsion system 40 and vehicle braking, including operation of the parking brake function of the drum-in-hat brakes assemblies 39. To this end, the control system 44 can include one or more controllers, such as a propulsion system controller, motor controller, and/or brake controller. That said, the control system 44 is connected to and receives signals from various sensors that monitor vehicle functions and environmental conditions.

For example, a vehicle speed/acceleration sensor 50 monitors the vehicle speed and acceleration and generates signals indicative thereof. A road grade sensor 52 can detect or calculate the slope of the road on which the vehicle 20 is driving and generate signals indicative thereof. An ignition sensor 54 generates signals indicative of ignition status. A wheel speed sensor 58 is provided on/adjacent to each wheel 32 and generates signals indicative of the speed at each wheel. The control system 44 also receives signals indicative of the degree—including velocity and acceleration—the brake pedal 42 is depressed.

The control system 44 can receive and interpret these signals and perform vehicle functions, e.g., braking, in response thereto. In one example, the control system 44 can detect wheel slip between one or more wheels 30, 32 and the driving surface based on the sensors 50, 58 and perform anti-lock braking (ABS) and/or electronic stability control (ESC) using one or more disc brakes 37. The control system 44 can also be connected to an alert 56 for notifying the driver/operator of the vehicle 20 of vehicle conditions, vehicle status, braking operations, and/or environmental conditions.

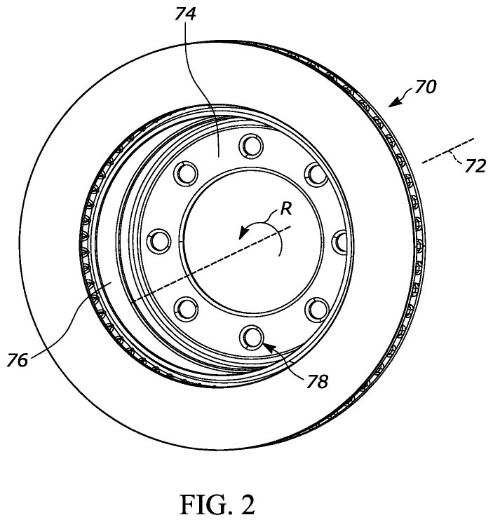

Referring to FIG. 2, the rotor 70 associated with each rear wheel 32 can be a drum-in-hat rotor centered on an axis 72. To this end, the rotor 70 includes a hat or brake drum 74 having an inner surface 76 configured as a braking surface for interacting with the drum brake assembly 39. Mounting holes 78 in the rotor 70 allow the drum brake assembly 39 to be secured thereto. The direction of rotation of the rotor 70 during normal driving of the vehicle 20 is indicated at R.

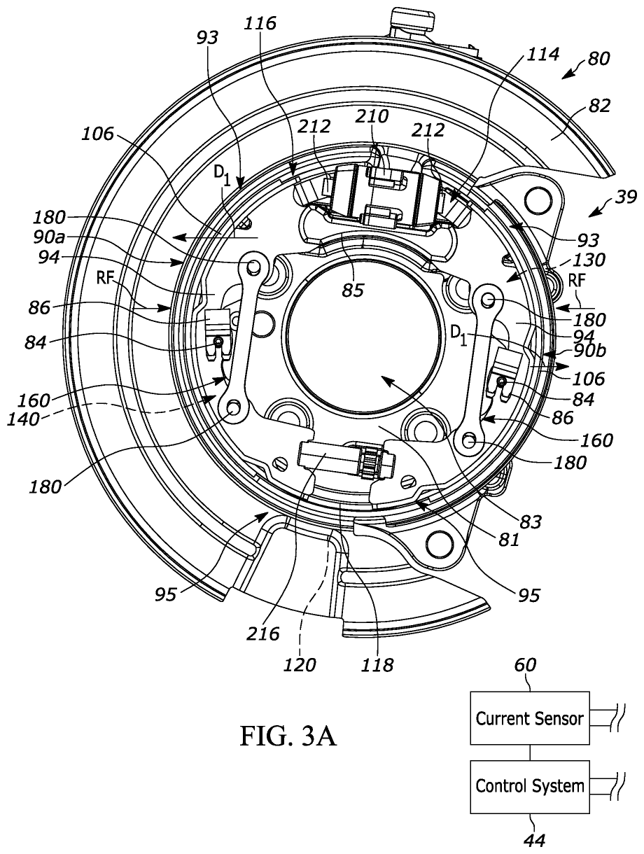

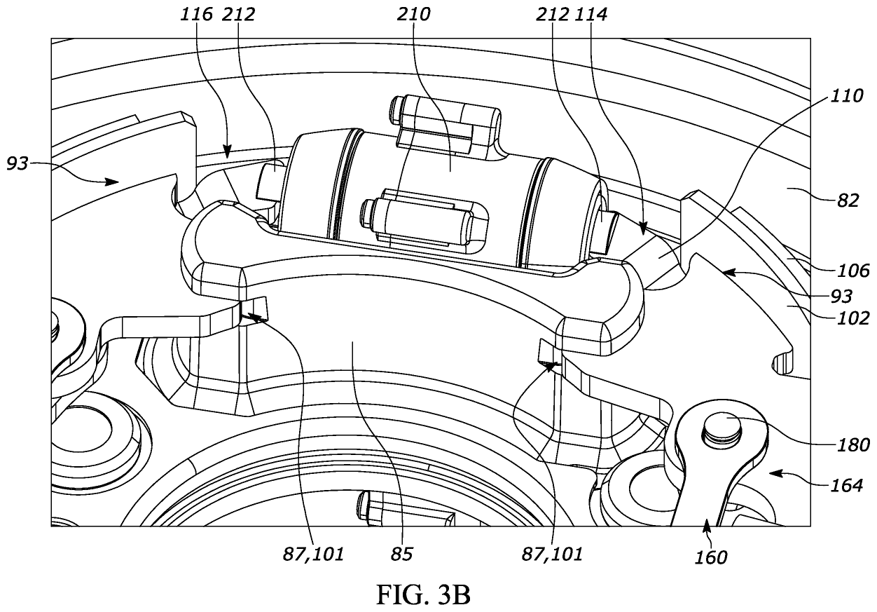

The drum brake assembly 39 includes an adapter assembly 80 (FIG. 3A) secured to the brake drum 74. The adapter assembly 80 includes a central adapter 81 having an opening 83. A lobe-shaped abutment 85 extends from the adaptor 81 and includes a pair of ends having slots 87 therein (see FIG. 3B). A splash shield 82 covers the adapter 81 and extends radially outward therefrom.

A pair of brake shoes 90a, 90b is mounted to the splash shield 82 on opposite sides of the opening 83. In particular, a hold down pin 84 extends from the splash shield 82 and through each brake shoe 90a, 90b. A spring 86 is secured to each pin 84 to keep the brake shoes 90a, 90b loaded against the splash shield 82 and therefore substantially in the same plane as one another. The constructions of the brake shoes 90a, 90b is identical and, thus, the description of only the brake shoe 90a is provided for brevity.

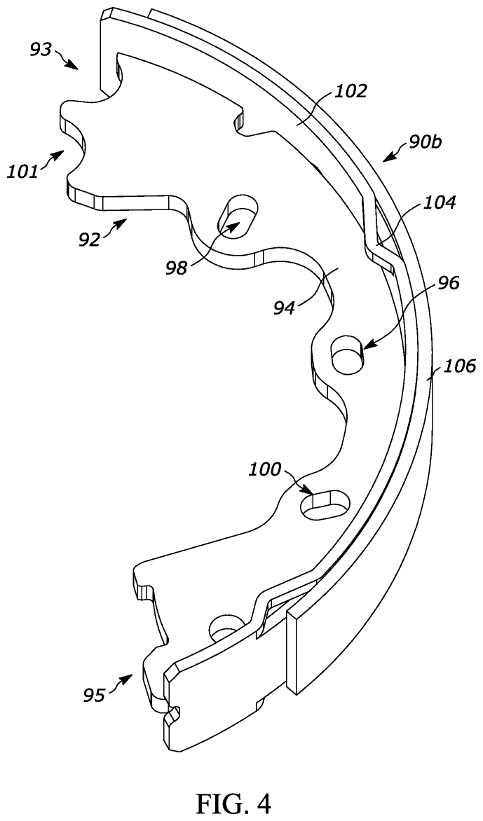

The brake shoe 90a is generally curved or arcuate and extends circumferentially about the opening 83 in the splash shield 82. Turning to FIG. 4, the brake shoe 90a includes a base 92 extending from a first end 93 to a second end 95. The base 92 includes a web portion 94 and a rim portion 102 extending perpendicular to the arcuate web portion. A notch 101 extends into the base 92 at the first end 93 of the brake shoe 90a and generally towards the rim portion 102.

The web portion 94 is generally flat and crescent-shaped. The web portion 94 bisects the rim portion 102. A first slot 96 extends through the web portion 94 generally in the middle of the base 92. A second slot 98 extends through the web portion 94 closer to the first end 93 of the base 92. A third slot 100 extends through the web portion 94 closer to the second end 95 of the base 92. The second and third slots 98, 100 are positioned on opposite sides of the first slot 96. Each of the slot 96, 98, 100 can be elongated or oval.

The rim portion 102 is arcuate and rigidly secured to the web portion 94, such as by welding. One or more shoe slides 104 are provided on the rim portion 102 and extend inwards generally towards the web portion 94. More specifically, the shoe slides 104 are formed as indentations arranged circumferentially along the rim portion 102. A friction pad 106 is secured or bonded to the outer arcuate surface of the rim portion 102. The friction pad 106 has the same shape and general contour as the inner surface 76 of the brake drum 74.

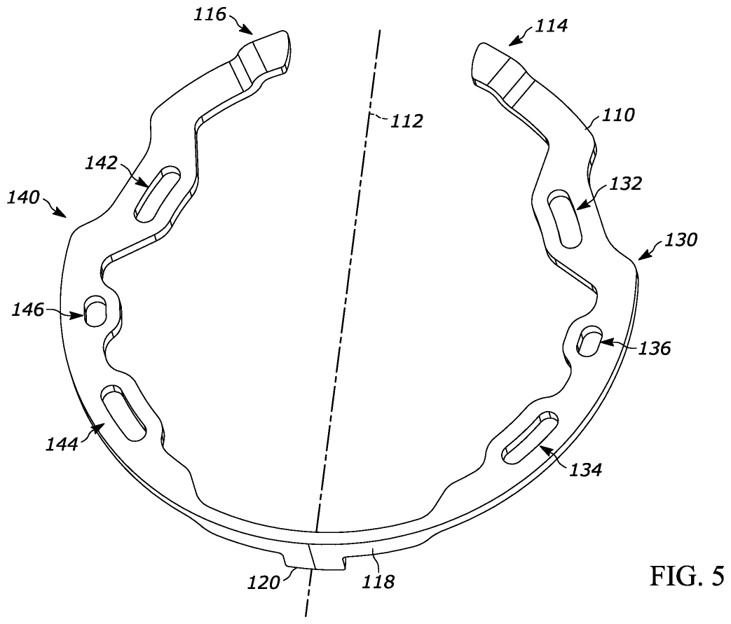

Turning to FIG. 5, a shoe spreader web 110 is connected to both brake shoes 90a, 90b. The web 110 has a centerline 112 and extends from a first end 114 to a second end 116. A middle portion 118 connects the ends 114, 116 and includes a projection 120 positioned generally on the centerline 112.

The web 110 includes a first side 130 and a second side 140 on opposite sides of the centerline 112. First and second slots 132, 134 extend through the first side 130. Each of the slots 132, 134 is elongated or oval. A slot 136 extends through the first side 130 and is positioned between the slots 132, 134. The slot 136 can be oval. The web 110 can be formed from a resilient material, such as metal, that allows for some relative movement between the first and second sides 130, 140 without plastic deformation.

First and second slots 142, 144 extend through the second side 140. Each of the slots 142, 144 is elongated or oval. A slot 146 extends through the second side 140 and is positioned between the slots 142, 144. The slot 146 can be oval. Consequently, the first and second sides 130, 140 of the web 110 are symmetric with one another about the centerline 112.

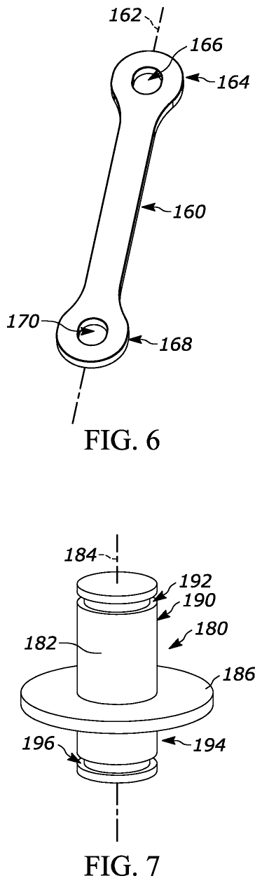

Referring to FIG. 6, a link 160 helps to connect each brake shoes 90a, 90b to the web 110 in a manner that allows for relative movement therebetween. Each link 160 is elongated and extends along a centerline 162 from a first end 164 to a second end 168. An opening 166 extends through the first end 164. An opening 170 extends through the second end 168. The link 160 may be symmetric as shown or asymmetric (not shown).

Pins 180 (FIG. 7) help to connect the links 160 to the brake shoes 90a, 90b and web 110. Each pin 180 includes a shaft 182 extending along a centerline 184. A flange 186 extends radially outward from the shaft 182 between the ends 164, 168. The flange 186 therefore splits the pin 180 into a first portion 190 (located above the flange as shown) and a second portion 194 (located below the flange as shown). An annular recess 192 extends into the first portion 190. An annular recess 196 extends into the second portion 194. As shown, the first portion 190 is longer than the second portion 194. The pins 180 are formed from a hardened, durable material that can be anti-rust coated.

Turning back to FIG. 3A, a linear actuator 210 is secured to the adapter 81 and positioned generally between the first ends 93 of the brake shoes 90a, 90b. In one example, the actuator is a wheel cylinder 210 having hydraulically actuated, opposing pistons 212. Each piston 212 has a clevis selectively coupled to the first end 93 of one of the brake shoes 90a, 90b and responsible for displacing the first ends, as will be discussed.

When the drum brake assembly 39 is assembled, the web 110 is positioned over the adapter 81 with the ends 114, 116 located adjacent the pistons 212. The projection 120 of the web 110 engages the splash shield 82 to prevent rotation of the web 110 when torque is applied on the brake. It will be appreciated that when the brake drum 74 is connected to the back plate assembly 80, the slots 132, 134, 142, 144 in the web 110 extend generally circumferentially about the axis 72 of the rotor 70. In other words, the slots 132, 134, 142, 144 are collectively concentric/substantially concentric with the inner surface 76 of the brake drum 74.

The ends 93 of the brake shoes 90a, 90b are held in the slots 87 of the abutment 85 beneath the tension spring, which help bias the ends 93 into the slots 87. The ends 95 of the brake shoes 90a, 90b are held by an adjusting mechanism 216 such that the brake shoes are suspended within the brake drum 74. The hold down pins 84 and associated springs 86 help keep the brake shoes 90a, 90b in the same plane.

The brake shoes 90a, 90b are mounted on the respective sides 130, 140 of the web 110 on the outboard side thereof. More specifically, the slots 98, 100 in the brake shoe 90a are aligned with the slots 132, 134 in the first side 130 of the web 110. The slot 96 in the brake shoe 90a is aligned with the slot 136 in the first side 130 of the web 110. The hold down pin 84 extends through the aligned slots 96, 136. The spring 86 connects to the exposed portion of the hold down pin 84 on the outboard side of the brake shoe 90a.

The opening 166 in one of the links 160 is aligned with the slots 98, 132. The opening 168 in the link 160 is aligned with the slots 100, 134. The first portion 192 of one of the pins 180 extends through the opening 166 in the link 160 and the slot 98 in the brake shoe 90a. The flange 186 of the pin 180 abuts the outboard side of the web 110. The second portion 194 of the pin 180 extends through the slot 132 in the web 110. Retaining clips (not shown) engage the respective recesses 192, 196 of this pin 180 to secure the first end 164 of the link 160 to the brake shoe 90a and web 110.

Similarly, the first portion 192 of another of the pins 180 extends through the opening 168 in the link 160 and the slot 100 in the brake shoe 90a. The flange 186 of the pin 180 abuts the outboard side of the web 110. The second portion 194 of the pin 180 extends through the slot 134 in the web 110. Retaining clips (not shown) engage the respective recesses 192, 196 of this pin 180 to secure the second end 168 of the link 180 to the brake shoe 90a and web 110.

Turing to the brake shoe 90b, the slots 98, 100 in the brake shoe 90b are aligned with the slots 142, 144 in the second side 140 of the web 110. The slot 96 in the brake shoe 90b is aligned with the slot 146 in the second side 140 of the web 110. Another hold down pin 84 extends through the aligned slots 96, 146. Another spring 86 connects to the exposed portion of the hold down pin 84 on the outboard side of the brake shoe 90b.

The opening 166 in another link 160 is aligned with the slots 98, 142. The opening 168 in the link 160 is aligned with the slots 100, 144. The first portion 192 of another of the pins 180 extends through the opening 166 in the link 160 and the slot 98 in the brake shoe 90b. The flange 186 of the pin 180 abuts the outboard side of the web 110. The second portion 194 of the pin 180 extends through the slot 142 in the web 110. Retaining clips (not shown) engage the respective recesses 192, 196 of this pin 180 to secure the first end 168 of the link 180 to the brake shoe 90b and web 110.

Similarly, the first portion 192 of another of the pins 180 extends through the opening 168 in the link 160 and the slot 100 in the brake shoe 90b. The flange 186 of the pin 180 abuts the outboard side of the web 110. The second portion 194 of the pin 180 extends through the slot 134 in the web 110. Retaining clips (not shown) engage the respective recesses 192, 196 of this pin 180 to secure the second end 168 of the link 180 to the brake shoe 90b and web 110.

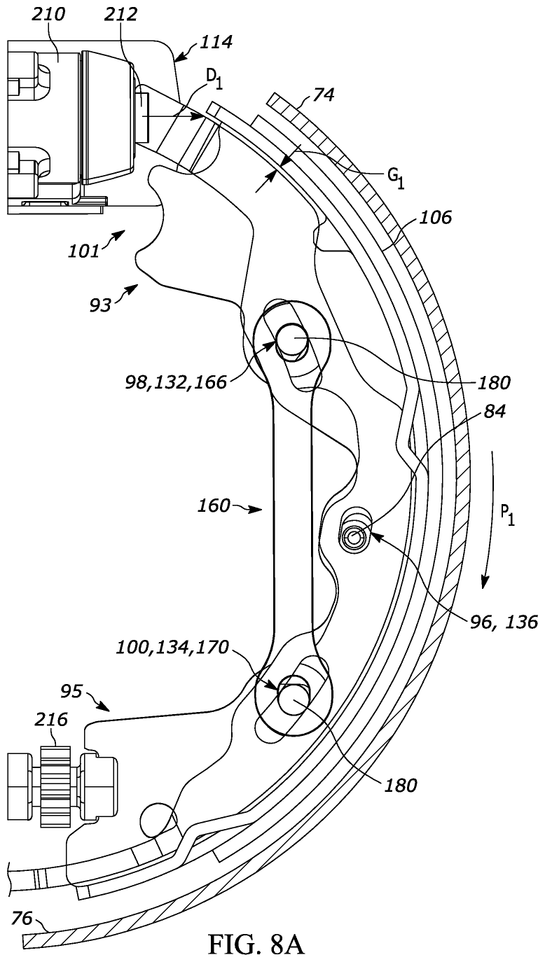

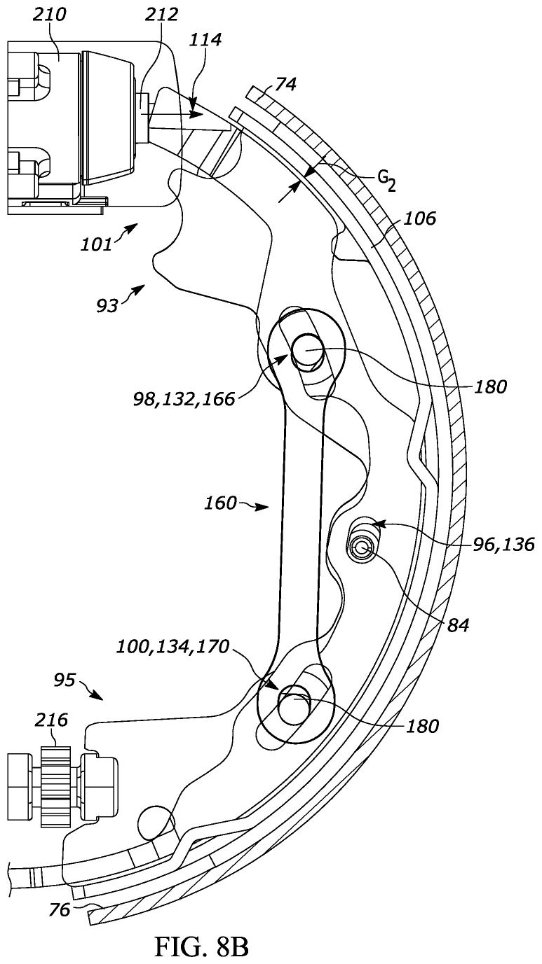

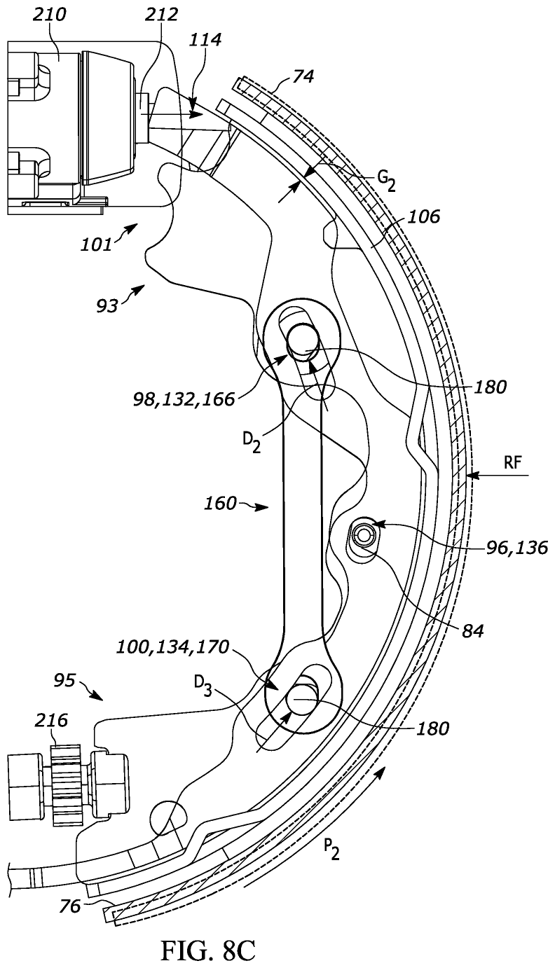

Referring to FIG. 8A, when the brake shoes 90a, 90b are connected to the web 110 via the pins 180 (and prior to performing a braking operation), a radial gap G₁ exists between the periphery of the web and the rim portion 102 of the respective brake shoe 90a, 90b. In one example, the radial gap G₁ can be on the order of about 2 mm, although alternative spacing is contemplated.

The ends 114, 116 of the web 110 are aligned with the clevis of each piston 212 on the wheel cylinder 210. Any number of mating connection or interface can be used to couple the pistons 212 to the respective ends 114, 116 of the web 110. To this end, the clevis of each piston 212 or ends 114, 116 of the web 110 can be U-shaped, T-shaped, tongue-in-groove, etc. Regardless, the brake shoes 90a, 90b are not directly connected to the pistons 212 but the pistons are capable of causing the ends 114, 116 of the web 110 to move, which thereby causes the brake shoes associated therewith to move.

As noted, the adjusting mechanism 216 is provided between and secured to the second ends 95 of the brake shoes 90a, 90b. The adjusting mechanism 216 is lengthened in a known manner, e.g., automatically or manually, as the friction pads 106 wear down to maintain a substantially constant radial spacing between the brake shoes 90a, 90b and the inner surface 76 prior to actuating the brakes. Consequently, the travel length of the pistons 212 for each brake application is substantially maintained as the friction pads 106 go through their service life.

The brake shoes 90a, 90b are selectively operable between braking and non-braking positions. In the braking position, the brake shoes 90a, 90b contact and press against the inner surface 76 of the brake drum 74 to slow or otherwise stop rotation of the rear wheel 32 (FIG. 1) to which the brake drum is rotationally fixed. In the non-braking position, the brake shoes 90a, 90b do not contact the inner surface 76 of the brake drum 74 and thereby allow the rear wheel 32 to rotate freely.

Operation of the brakes is illustrated in FIGS. 8A-8C. It will be appreciated that some of the components shown therein are partially transparent to assist in understanding the invention. During operation of the vehicle 20, the driver depresses the brake pedal 42 (see also FIG. 1) to operate the disc brake assemblies 37 and apply hydraulic service braking to one or more wheels 30, 32. This can position the vehicle 20 on a hill (uphill or downhill). In any case, while the brake pedal 42 remains depressed, the driver can then apply the parking brake, e.g., electronically, by pushing a button.

The control system 44 can receive signals from one or more of the sensors, e.g., the brake pedal sensor, vehicle speed sensor 50, road grade sensor 52 and/or wheel speed sensor 58, and determine that actuating the parking brake is appropriate. In response, the control system 44 actuates the wheel cylinder 210 associated with each rear wheel 32 (see FIG. 8A). The pistons 212 in each wheel cylinder 210 are moved outward away from each other, thereby moving into engagement with and pushing the ends 114, 116 of the web 110 secured thereto away from one another in the direction D₁.

At the time the parking brake is requested, the brake shoes 90a, 90b are spaced from the abutment 85 because there is no torque, or braking force, being applied to the brake shoes. Rather, the torque at the time of request is held via the calipers on the disc brake assemblies 37 due to the hydraulic pressure induced by depression of the brake pedal 42. Once the brake pedal 42 is released, however, one of the brake shoes 90a, 90b moves into engagement with the abutment 85, i.e., the slot(s) 101 on the respective brake shoes 90a, 90b engage the slot(s) 87 on the abutment, as the torque needed to hold the vehicle 20 stationary on the hill is transferred to the drum brake assemblies 39.

With that said, since the pins 180 connect the brake shoes 90a, 90b to the web 110, outward movement of the ends 114, 116 likewise results in outward movement of the brake shoes. More specifically, as the end 114 is moved outward by the piston 212 in the direction D₁, the end 114 applies load, via the web 110, primarily to the pin 180 positioned within the overlapping/intersecting slots 98, 132 and opening 166 in link 160. Load is simultaneously applied at a lesser extent to the pin 180 positioned within the overlapping/intersecting slots 100, 134 and the opening 170 in link 160. This, in turn, applies load to the brake shoe 90a.

In other words, in a first condition of the brake shoes 90a, 90b the pins 180 help transfer the wheel cylinder 210 apply loads from the slots 132, 134 in the web 110 to the slots 98, 100 in the brake shoe 90a. The end 116 cooperates similarly with one of the pins 180 positioned within the aligned slots 98, 142 and opening 166 to apply load to the brake shoe 90b (not shown).

The brake shoes 90a, 90b are initially spaced from the inner surface 76 of the brake drum 74, and, thus, there is little to no initial resistance to outward movement of the brake shoes towards the inner surface 76. Consequently, each brake shoe 90a, 90b pivots outward about its respective end 95 in the manner indicated generally at P₁(clockwise as shown) until the friction pad 106 engages the inner surface 76 of the brake drum 74 to apply braking force thereto. At the same time, the slot 101 in the first end 93 of the brake shoe 90a is moved out of engagement with the corresponding slot 87 in the abutment 85. The slot 101 in the first end 93 of the brake shoe 90b, however, is kept in engagement with the corresponding slot 87 due to the rotation of the drum 74 in the direction P1 (clockwise direction).

Engaging the friction lining 106 with the inner surface 76, however, prevents further movement of the friction lining. That said, and turning to FIG. 8B, as the wheel cylinder 210 continues advancing the pistons 212 to increase the braking force, the web 110 slips on the pins 180 and moves outwards towards/relative to the rim portion 102 of the respective brake shoe 90a, 90b. More specifically, the first side 130 slips relative to the brake pad 90a such that the position of the pins 180 within the slots 132, 134 changes as the shoes 90a, 90b move into contact with abutment 85. Similarly, the second side 140 slips relative to the brake pad 90b such that the position of the pins 180 within the slots 142, 144 changes. At the same time, the positions of the hold down pins 84 within the slots 96 of the respective brake pad 90a, 90b changes. Consequently, the radial gap G₁ is reduced to a smaller radial gap G₂, which can be about 1 mm.

The wheel cylinder 210 is actuated until the current draw on the wheel cylinder reaches a predetermined value, at which point the wheel cylinder is turned off. The current draw can be measured and monitored by a current sensor 60 (see also FIG. 1) connected to the wheel cylinder 210 and the control system 44. Turning the wheel cylinder 210 off locks the pistons 212 in position and therefore locks the brake shoes 90a, 90b in the braking condition applying the parking brake force to the inner surface 76 of the brake drum 74. The brake drum 74, in turn, exerts reaction forces (indicated generally at RF in FIG. 3A) on the brake shoes 90a, 90b. The reaction forces RF are transferred from the friction pads 106, through the pins 84, 180, to the ends 114, 116 of the web 110, and ultimately to the pistons 212. Consequently, the locked pistons 212 oppose the reaction forces RF applied by the brake drum 74 to the brake shoes 90a, 90b.

It will be appreciated that depending on the driving and/or braking conditions, the brake drum 74 can undergo thermal expansion which affects the application of the parking brake. As a result, the travel distance of the pistons 212 increases to accommodate the extra clearance needed to reach the inner surface 76. That said, once the parking brake is applied and the vehicle 20 remain stationary over a long period of time, e.g., overnight, the brake drum 74 naturally begins to cool. More specifically, the inner surface 76 of the brake drum 74 contracts, reducing its diameter as it cools, forcing the brake shoes 90a, 90b and wheel cylinder 210 to accommodate. This can undesirably increase reaction forces RF borne by the locked pistons 212.

With this in mind, the drum brake assembly 39 of the present invention is specifically configured to take up/absorb these reaction forces and prevent undesirable stress on the wheel cylinder 210 during thermal contraction of the brake drum 74. To this end, and referring to FIG. 8C, the web 110 and brake shoes 90a, 90b are connected to one another in a manner that allows one or both brake shoes to move relative to the web during thermal contraction of the brake drum to help avoid unnecessary loading of the pistons 212.

As noted, as the brake drum 74 cools, the reaction forces RF applied by the contracting inner surface 76 to the brake shoes 90a, 90b increase. As noted, the brake shoe 90b is fixed in position against the abutment 85. That said, the cooling brake drum 74 causes the brake shoe 90b to pivot about its fixed first end 93, thereby causing the second end 95 to act on/push the adjusting mechanism 216 towards the second end 95 of the brake shoe 90a in the manner indicated generally at T in FIG. 8C. This, in turn, causes the adjusting mechanism 216 to push the second end 95 of the brake shoe 90a in the manner T.

Since the brake shoe 90a is secured to the web 110, and the first end 114 of the web is prevented from moving towards the locked/unactuated wheel cylinder 210 (due to the locked pistons 212), pushing the brake shoe 90a in the manner T attempts to move the brake shoe 90a (with the pins 180 and link 160 attached thereto) relative to the fixed web 110.

When the reaction forces RF causing pushing T of the second end 95 of the brake shoe 90a reach or exceed a predetermined amount, the brake shoe 90a slips on the inner surface 76 of the drum 74 by pivoting in the manner P₂ (counterclockwise as shown) relative to the drum. This occurs because the elongated configuration of the slots 132, 134 in the web 110 and the corresponding slots 98, 100 in the brake shoe 90a permit sliding movement of the pins 180 within the slots. Moreover, as the brake shoes 90a, 90b reposition due to the contracting brake drum 74, the web 110 is prevented from rotation due to its interlink with the splash shield 82 and/or adapter 81 via the projection 120 of web 110. The link 160 maintains a generally fixed distance between the pins 160 extending therethrough during any movement of the pins within/relative to the slots 132, 134. More specifically, the pin 180 within the slot 132 moves in the manner D₂ relative to the web 110. The pin 180 within the slot 134 moves in the manner D₃ relative to the web 110. The pins 180 in the slots 98, 100 may or may not also slide within and relative to the slots 98, 100 while moving with the brake shoe 90a.

In any case, sliding the pins 180 within the slots 132, 134 allows the entire brake shoe 90a secured to the pins to move inwardly towards the opening 83 in the adapter 81 to accommodate the contracting brake drum 74. That said, the additional reaction forces RF are absorbed by the brake shoe 90a moving relative to the web 110, thereby reducing the force transferred to the pistons 212. As a result, the radial gap G₂ is reduced to a smaller radial gap G₃, which can be less than about 1 mm. The brake shoe 90a can pivot in the manner P₂ until the slot 101 on the brake shoe 90a abuts the slot 87 on the abutment 85.

During this movement, the flanges 186 on the pins 180 not only provide load stability between the web 110 and brake shoes 90a, 90b but also act as spacers between the web and brake shoes. Since brake shoe 90a movement occurs independent from the web 110, the wheel cylinder 210 is able to maintain load on the ends 114, 116 of the web 110 during brake shoe shift and wrap.

Furthermore, even though the brake shoe(s) 90a, 90b shift, the web 110 stays in place and therefore the pins 180 are still able provide a reaction/transferring force to the slots 98, 100 of the shifted brake shoe(s). With this in mind, the generally concentric orientation of the slots 132, 134, 142, 144 in the web 110 facilitates independent movement of the brake shoes 90a, 90b relative to the web and helps maintain braking force during brake shoe shift.

Additionally, providing the links 180 on the brake shoes 90a, 90b helps to ensure the brake shoes can be applied to the drum 74 at the necessary load and that a contracting drum causing shoe shift does not also cause the web 110 to contract. To this end, the pins 180 shift with the brake shoes 90a, 90b in the concentric slots 132, 134, 142, 144 during brake drum 74 contraction.

When the parking brake is released (the braking operation is complete/terminated), the control system 44 activates the wheel cylinder 210 to retract the pistons 212. This removes the reaction forces RF on the brake shoes 90a, 90b and thereby allows the web 110 to relax and pull the brake shoes 90a, 90b back to their initial position relative to the web 110. In other words, the resilient construction of the web 110 pulls the brake shoes 90a, 90b to slide the pins 180 attached thereto within and relative to the cooperating slots 98, 100, 132, 134, 142, 144 until the brake shoes return to the positions shown in FIG. 8A. This, in turn, returns the radial spacing between the rim portions 102 and periphery of the web 110 to the gap G₁.

It will therefore be appreciated that the web 110 can replace one or both tension springs (not shown) typically used to automatically draw the brake shoes 90a, 90b away from the inner surface 76 of the drum 74 when the parking brake is released. In such constructions, one tension spring (not shown) can be secured to the sides of the brake shoes 90a, 90b facing away from the splash shield 82. Another tension spring (not shown) can be secured to the opposing sides of the brake shoes 90a, 90b facing towards the splash shield 82. That said, the resilience of the web 110 helps to alleviate the need for one/both tension springs.

The present invention is advantageous in that it allows the brake shoes to move relative to the web during brake drum contraction in a manner that help mitigate stress on the wheel cylinder. To this end, the brake shoes are indirectly—not directly—connected to the wheel cylinder to accommodate their movement while the web remains connected to the wheel cylinder pistons. Shifting the brake shoes relative to the web allows the wheel cylinder to maintain its load on the ends of the web regardless of road grade or drum temperature when the vehicle is parked.

Furthermore, the slots in the shoes are configured to be generally concentric with the inner surface of the brake drum while the slots in the web extend at an angle relative to the brake shoe slots. That said, shifting of the shoes relative to the web is facilitated while maintaining braking force on the drum.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. An apparatus for a drum brake assembly having a brake drum and an actuator, comprising:
a shoe spreader web comprising:
a first side for connecting to a first piston of the actuator;
a second side for connecting to a second piston of the actuator;
a first brake shoe secured to the first side of the web; and
a second brake shoe secured to the second side of the web, the brake shoes having a first condition in which the respective first and second sides of the web move the brake shoes to apply braking force to the brake drum in response to actuation of the actuator, the first brake shoe having a second condition moving relative to the web for absorbing brake drum contraction forces.

2. The apparatus recited in claim 1, further comprising pins extending through first and second slots in each of the first and second sides of the web and through corresponding first and second slots in each of the first and second brake shoes for connecting the brake shoes to the web.

3. The apparatus recited in claim 2, wherein the first and second slots in the first side of the web are elongated such that the pins are movable with the first brake shoe relative to the first and second slots in the first side of the web for absorbing brake drum contraction forces.

4. The apparatus recited in claim 2, further comprising a link having a first opening for receiving the pin in the first slot in the first side of the web and a second opening for receiving the pin in the second slot in the first side of the web such that the pins maintain a fixed distance from one another while the first brake shoe moves relative to the web.

5. The apparatus recited in claim 2, wherein the first and second slots in the first and second sides of the web are collectively circumferentially arranged about a common axis.

6. The apparatus recited in claim 2, wherein the pins transfer actuator loads from the first and second sides of the web to the respective first and second brake shoes.

7. The apparatus recited in claim 2, wherein each of the slots in the web extends transverse to the corresponding slot in the first and second brake shoes.

8. The apparatus recited in claim 1, wherein the second brake shoe pushes the first brake shoe to move the first brake shoe relative to the web in response to brake drum contraction forces.

9. The apparatus recited in claim 1, wherein the brake shoes are free of direct connection with the actuator.

10. The apparatus recited in claim 1, wherein the second brake shoe has a second condition moving relative to the web for absorbing brake drum contraction forces.

11. The apparatus recited in claim 1, wherein the web is substantially C-shaped and extends to opposite sides of the actuator.

12. The apparatus recited in claim 11, wherein the web includes a projection between the first and second sides for engaging the brake drum assembly to maintain the position of the web during brake drum rotation and/or contraction.

13. The apparatus recited in claim 1, wherein the first brake shoe includes a web portion including the first and second slots and a rim portion bearing a friction lining for engaging the brake drum, wherein the shoe spreader web is spaced from the brake shoe rim portion by a radial gap that is reduced to a non-zero amount during brake drum contraction.

14. The apparatus recited in claim 1, wherein the web automatically pulls the first and second brake shoes away from the brake drum when the braking force is released from the brake drum.

15. An apparatus for a drum brake assembly having a brake drum and an actuator, comprising:
a shoe spreader web comprising:
a first side for connecting to a first piston of the actuator and including first and second slots;
a second side for connecting to a second piston of the actuator and including first and second slots, the first and second slots in the first and second sides of the web being collectively circumferentially arranged about a common axis;
a first brake shoe secured to the first side of the web including first and second slots;
a second brake shoe secured to the second side of the web and including first and second slots;
pins extending through the first and second slots in each of the first and second sides of the web and through the corresponding first and second slots in each of the first and second brake shoes for connecting the brake shoes to the web and transferring actuator loads from the first and second sides of the web to the respective first and second brake shoes;
the brake shoes having a first condition in which the respective first and second sides of the web move the brake shoes to apply braking force to the brake drum in response to actuation of the actuator, the first brake shoe having a second condition moving relative to the web for absorbing brake drum contraction forces.

16. The apparatus recited in claim 15, wherein the first and second slots in the first side of the web are elongated such that the pins are movable with the first brake shoe relative to the first and second slots in the first side of the web for absorbing brake drum contraction forces and for brake drum rotation during torque transfer from service brakes to the drum parking brake.

17. The apparatus recited in claim 15, further comprising a link having a first opening for receiving the pin in the first slot in the first side of the web and a second opening for receiving the pin in the second slot in the first side of the web such that the pins maintain a fixed distance from one another while the first brake shoe moves relative to the web.

18. The apparatus recited in claim 15, wherein each of the slots in the web extends transverse to the corresponding slot in the first and second brake shoes.

19. The apparatus recited in claim 15, wherein the second brake shoe pushes the first brake shoe to move the first brake shoe relative to the web in response to brake drum contraction forces.

20. The apparatus recited in claim 15, wherein the brake shoes are free of direct connection with the actuator.

21. The apparatus recited in claim 15, wherein the second brake shoe has a second condition moving relative to the web for absorbing brake drum contraction forces.

22. The apparatus recited in claim 15, wherein the web is substantially C-shaped and extends to opposite sides of the actuator.

23. The apparatus recited in claim 15, wherein the web includes a projection between the first and second sides for engaging the brake drum assembly to maintain the position of the web during brake drum contraction.

24. The apparatus recited in claim 15, wherein the first brake shoe includes a web portion including the first and second slots and a rim portion bearing a friction lining for engaging the brake drum, wherein the web is spaced from the rim portion by a radial gap that is reduced to a non-zero amount during brake drum contraction.

25. The apparatus recited in claim 15, wherein the web automatically pulls the first and second brake shoes away from the brake drum when the braking force is released from the brake drum.
